(19) United States
(12) Patent Application Publication
(10) Pub. No.: US 2021/0232806 A1
(43) Pub. Date: Jul. 29, 2021

(54) IMAGE PROCESSING METHOD AND DEVICE, PROCESSOR, ELECTRONIC EQUIPMENT AND STORAGE MEDIUM

(71) Applicant: Beijing SenseTime Technology Development Co., Ltd., Beijing (CN)

(72) Inventors: Yue He, Beijing (CN); Yunxuan Zhang, Beijing (CN); Siwei Zhang, Beijing (CN); Cheng Li, Beijing (CN)

(21) Appl. No.: 17/227,846

(22) Filed: Apr. 12, 2021

Related U.S. Application Data
(63) Continuation of application No. PCT/CN2019/105767, filed on Sep. 12, 2019.

(30) Foreign Application Priority Data
Jul. 30, 2019 (CN) 201910694065.3

(51) Int. Cl. G06K 9/00; G06T 7/40; G06T 3/40; G06T 3/00; G06T 11/00; G06K 9/62

(52) U.S. Cl. CPC G06K 9/00281; G06T 7/40; G06T 3/40; G06T 3/0006; G06T 2207/20084; G06K 9/6262; G06T 2207/30201; G06T 2207/20221; G06T 2207/20081; G06T 11/001

(57) ABSTRACT

The disclosure relates to a method and apparatus for image processing, a processor, an electronic device and a storage medium. The method includes: acquiring a reference face image and a reference face pose image; encoding the reference face image to obtain face texture data of the reference face image; performing face key point extraction on the reference face pose image to obtain a first face mask of the reference face pose image; and obtaining a target image according to the face texture data and the first face mask.

### CROSS-REFERENCE TO RELATED APPLICATIONS

This application is a continuation of International Application No. PCT/CN2019/105767, filed on Sep. 12, 2019, which claims priority to Chinese Patent Application No. 201910694065.3, filed to the China National Intellectual Property Administration on Jul. 30, 2019 and entitled “Method and apparatus for image processing, processor, electronic device and storage medium”. The disclosures of International Application No. PCT/CN2019/105767 and Chinese Patent Application No. 201910694065.3 are hereby incorporated by reference in their entireties.

### BACKGROUND

With development of Artificial Intelligence (AI) technologies, the AI technologies have been applied more extensively. For example, “face swapping” may be performed for a person in a video or an image through the AI technology. “Face swapping” refers to reserving a face pose in the video or the image and swapping face texture data in the video or the image with face texture data of a target person, so as to swap the face of the person in the video or the image with the face of the target person. The face pose includes position information of a face contour, position information of five organs and facial expression information, and the face texture data includes luster information of facial skin, skin color information of the facial skin, wrinkle information of the face and texture information of the facial skin.

According to a conventional method, a neural network is trained by using a large number of images containing a face of a target person as a training set, and a reference face pose image (i.e., an image containing face pose information) and a reference face image containing the face of the target person may be input to the trained neural network to obtain a target image. A face pose in the target image is a face pose in the reference face image, and a face texture in the target image is a face texture of the target person.

### SUMMARY

The disclosure relates to the technical field of image processing, and particularly to a method and apparatus for image processing, a processor, an electronic device and a storage medium.

In a first aspect, provided is a method for image processing, including: acquiring a reference face image and a reference face pose image; encoding the reference face image to obtain face texture data of the reference face image. performing face key point extraction on the reference face pose image to obtain a first face mask of the reference face pose image; and obtaining a target image according to the face texture data and the first face mask.

In a second aspect, provided is an apparatus for image processing, including: an acquisition unit, configured to acquire a reference face image and a reference face pose image; a first processing unit, configured to encode the reference face image to obtain face texture data of the reference face image and perform face key point extraction on the reference face pose image to obtain a first face mask of the reference face pose image; and a second processing unit, configured to obtain a target image according to the face texture data and the first face mask.

In a third aspect, provided is a processor, which may be configured to execute the method of the first aspect and any possible implementation thereof.

In a fourth aspect, provided is an apparatus for image processing, including: a processor and a memory configured to store instructions which, when being executed by the processor, cause the processor to: acquire a reference face image and a reference face pose image; encode the reference face image to obtain face texture data of the reference face image and perform face key point extraction on the reference face pose image to obtain a first face mask of the reference face pose image; and obtain a target image according to the face texture data and the first face mask.

In a fifth aspect, provided is a non-transitory computer-readable storage medium having stored thereon a computer program containing program instructions that, when executed by a processor of an electronic device, causes the processor to execute a method for image processing, the method including: acquiring a reference face image and a reference face pose image; encoding the reference face image to obtain face texture data of the reference face image; performing face key point extraction on the reference face pose image to obtain a first face mask of the reference face pose image; and obtaining a target image according to the face texture data and the first face mask.

In a sixth aspect, provided is a computer program including computer-readable code that, when running in an electronic device, causes a processor in the electronic device to execute the method of the first aspect and any possible implementation thereof. It is to be understood that the above general description and the following detailed description are only exemplary and explanatory and not intended to limit the disclosure.

### BRIEF DESCRIPTION OF THE DRAWINGS

In order to describe the technical solutions in the embodiments of the disclosure or a background art more clearly, the drawings required to be used for descriptions about the embodiments of the disclosure or the background will be described below.

The accompanying drawings, which are incorporated in and constitute a part of this specification, illustrate embodiments consistent with the disclosure and, together with the specification, serve to describe the technical solutions of the disclosure.

FIG. 1 illustrates a schematic flowchart of a method for image processing according to an embodiment of the disclosure.

FIG. 2 illustrates a schematic diagram of face key points according to an embodiment of the disclosure.

FIG. 3 illustrates a schematic diagram of an architecture of decoding layers and fusion according to an embodiment of the disclosure.

FIG. 4 illustrates a schematic diagram of elements at same positions in different images according to an embodiment of the disclosure.

FIG. 5 illustrates a schematic flowchart of another method for image processing according to an embodiment of the disclosure.

FIG. 6 illustrates a schematic flowchart of another method for image processing according to an embodiment of the disclosure.

FIG. 7 illustrates a schematic diagram of an architecture of decoding layers and target processing according to an embodiment of the disclosure.

FIG. 8 illustrates a schematic diagram of another architecture of decoding layers and target processing according to an embodiment of the disclosure.

FIG. 9 illustrates a schematic flowchart of another method for image processing according to an embodiment of the disclosure.

FIG. 10 illustrates a schematic diagram of an architecture of a face generation network according to an embodiment of the disclosure.

FIG. 11 illustrates a schematic diagram of a target image obtained based on a reference face image and a reference face pose image according to an embodiment of the disclosure.

FIG. 12 illustrates a schematic structural diagram of an apparatus for image processing according to an embodiment of the disclosure.

FIG. 13 illustrates a schematic diagram of a hardware structure of an image processing apparatus according to an embodiment of the disclosure.

### DETAILED DESCRIPTION

In order to make the solutions of the disclosure better understood by those skilled in the art, the technical solutions in the embodiments of the disclosure will be clearly and completely described below in combination with the drawings in the embodiments of the disclosure. It is apparent that the described embodiments are not all embodiments but only part of embodiments of the disclosure. All other embodiments obtained by those of ordinary skill in the art on the basis of the embodiments in the disclosure without creative work shall fall within the scope of protection of the disclosure. Terms “first”, “second” and the like in the specification, claims and drawings of the disclosure are used not to describe a specific sequence but to distinguish different objects. In addition, terms “include” and “have” and any transformations thereof are intended to cover non-exclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

In the disclosure, term “and/or” is only an association relationship describing associated objects and represents that three relationships may exist. For example, A and/or B may represent three conditions: i.e., independent existence of A, existence of both A and B, and independent existence of B. In addition, term “at least one” in the disclosure represents any one of multiple or any combination of at least two of multiple. For example, including at least one of A, B and C may represent including any one or more elements selected from a set formed by A, B and C. “Embodiment” mentioned herein means that a specific feature, structure or characteristic described in combination with an embodiment may be included in at least one embodiment of the disclosure. Positions where this phrase appears in the specification do not always refer to the same embodiment as well as an independent or alternative embodiment mutually exclusive to another embodiment. It is explicitly and implicitly understood by those skilled in the art that the embodiments described in the disclosure may be combined with other embodiments.

With the technical solutions provided in the embodiments of the disclosure, the facial expression, five organs and face contour of a target person in a reference face image may be wrapped with the facial expression, face contour and five organs in a reference face pose image while reserving face texture data in the reference face image, to obtain a target image. The facial expression, five organs and face contour in the target image being highly matched with the facial expression, five organs and face contour in the reference face pose image represents high quality of the target image. Similarly, face texture data in the target image being highly matched with the face texture data in the reference face image also represents that high quality of the target image. The embodiments of the disclosure will be described below in combination with the drawings in the embodiments of the disclosure.

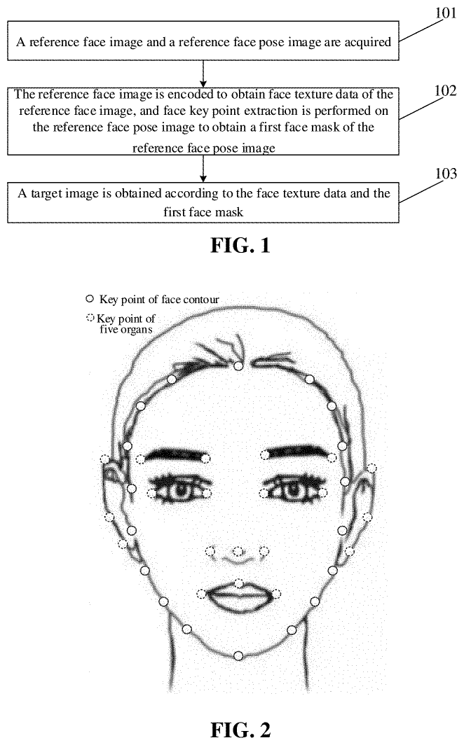

FIG. 1 illustrates a schematic flowchart of a method for image processing according to an embodiment of the disclosure. The method for image processing provided in the embodiment of the disclosure may be executed by a terminal device or a server or another processing device. The terminal device may be User Equipment (UE), a mobile device, a user terminal, a terminal, a cell phone, a cordless phone, a Personal Digital Assistant (PDA), a handheld device, a computing device, a vehicle device, a wearable device or the like. In some possible implementations, the method for image processing may be implemented by a processor calling computer-readable instructions stored in a memory.

In 101, a reference face image and a reference face pose image are acquired.

In the embodiment of the disclosure, the reference face image refers to a face image containing a target person, and the target person refers to a person whose expression and face contour are to be swapped. For example, Zhang San wants to swap an expression and face contour in a self-portrait ‘a’ with an expression and face contour in an image ‘b’; in such a case, the self-portrait ‘a’ is a reference face image and Zhang San is a target person.

In the embodiment of the disclosure, the reference face pose image may be any image containing a face. The reference face image and/or the reference face pose image may be acquired in by way of: receiving the reference face image and/or reference face pose image input by a user through an input component. The input component includes a keyboard, a mouse, a touch screen, a touchpad, an audio input unit or the like. The reference face image and/or the reference face pose image may also be acquired in by way of: receiving the reference face image and/or reference face pose image sent from a terminal. The terminal includes a mobile phone, a computer, a tablet computer, a server or the like. The manner of acquiring the reference face image and the reference face pose image is not limited in the disclosure.

In 102, the reference face image is encoded to obtain face texture data of the reference face image, and face key point extraction is performed on the reference face pose image to obtain a first face mask of the reference face pose image.

In the embodiment of the disclosure, encoding may be convolution, or may be a combination of convolution, normalization and activation.

In a possible implementation, the reference face image is encoded by multiple successive encoding layers. Each encoding layer includes convolution, normalization and activation, and the convolution, the normalization and the activation are sequentially cascaded. Namely, output data of the convolution serves as input data of the normalization, and output data of the normalization serves as input data of the activation. The convolution may be implemented by using a convolution kernel to perform convolution on data that is input to the encoding layer. By performing convolution on the input data of the encoding layer, feature information can be extracted from the input data of the encoding layer, and a size of the input data of the encoding layer can be reduced to reduce a calculation burden for subsequent processing. By normalizing the data having subjected to the convolution, correlations between different data in the data having subjected to the convolution can be eliminated, and differences in distribution between the different data in the data having subjected to the convolution becomes prominent, thus facilitating continued extraction of feature information from the normalized data through subsequent processing. The activation may be implemented by substituting the normalized data into an activation function. Optionally, the activation function is a Rectified Linear Unit (ReLU).

In the embodiment of the disclosure, the face texture data includes at least skin color information of facial skin, luster information of the facial skin, wrinkle information of the facial skin and texture information of the facial skin.

In the embodiment of the disclosure, face key point extraction refers to extracting position information of a face contour, position information of five organs and facial expression information in the reference face pose image. The position information of the face contour includes coordinates of key points on the face contour in a coordinate system of the reference face pose image. The position information of the five organs includes coordinates of key points of the five organs in the coordinate system of the reference face pose image.

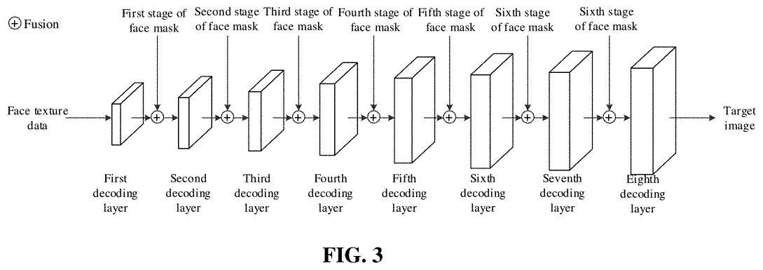

As an example, as illustrated in FIG. 2, face key points include key points of the face contour and key points of the five organs. The key points of the five organs include key points of an eyebrow region, key points of an eye region, key points of a nose region, key points of a mouth region and key points of an ear region. The key points of the face contour include key points on a face contour line. It is to be understood that the number and positions of the face key points illustrated in FIG. 2 are only an example provided in the embodiment of the disclosure and shall not constitute limitation to the disclosure.

The key points of the face contour and the key points of the five organs may be adjusted according to a practical effect in implementing the embodiment of the disclosure by the user. The face key point extraction may be implemented through any face key point extraction algorithm, and no limitation is set in the disclosure.

In the embodiment of the disclosure, the first face mask includes position information of the key points of the face contour, position information of the key points of the five organs, and the facial expression information. For convenience of expression, the position information of the face key points and the facial expression information are referred to a face pose hereinafter.

It is to be understood that, in the embodiment of the disclosure, the two processes of obtaining the face texture data of the reference face image and obtaining the first face mask of the reference face pose image may be executed in any order. The first face mask of the reference face pose image may be obtained after the face texture data of the reference face image is obtained, or the first face mask of the reference face pose image may be obtained before the face texture data of the reference face image is obtained. Alternatively, face key point extraction may be performed on the reference face pose image to obtain the first face mask of the face pose image while the reference face image is being encoded to obtain the face texture data of the reference face image.

In 103, a target image is obtained according to the face texture data and the first face mask.

For the same person, face texture data is constant. That is to say, if different images contain the same person, the same face texture data may be obtained by encoding the different images. That is, similar to the case where fingerprint information and iris information may serve as identity information of a person, face texture data may also be considered as identity information of a person. Therefore, if a neural network is trained by taking a large number of images containing the same person as a training set, the neural network can learn face texture data of the person in the images by training, so as to obtain a trained neural network. Due to that the trained neural network includes the face texture data of the person in the images, when the trained neural network is used in image generation, an image containing the face texture data of the person can be obtained. For example, if a neural network is trained by taking 2,000 images containing the face of Li Si as a training set, the neural network learns face texture data of Li Si from the 2,000 images during training. When the trained neural network in generating an image, face texture data in a finally obtained target image is the face texture data of Li Si, regardless whether a person in an input reference face image is Li Si. That is, a person in the target image is Li Si.

In the embodiment of the disclosure, in 102, the reference face image is encoded to obtain the face texture data in the reference face image without extracting a face pose from the reference face image. It is realized that face texture data of a target person can be obtained from any reference face image, while the face texture data of the target person contains no face pose of the target person. Then, face key point extraction is performed on the reference face pose image to obtain the first face mask of the reference face pose image without extracting face texture data from the reference face pose image. It is realized that any target face pose (for swapping the face pose of the person in the reference face image) can be obtained while the target face pose contains no face texture data in the reference face pose image. In such case, by subsequently performing operations such as decoding and fusion on the face texture data and the first face mask, a matching degree of face texture data of a person in the obtained target image with the face texture data in the reference face image can be improved, and a matching degree of the face pose in the target image with the face pose in the reference face pose image can be improved, thus improving the quality of the target image. A higher matching degree between the face pose of the target image and the face pose of the reference face pose image represents a higher similarity between the five organs, contour and facial expression of the person in the target image and the five organs, contour and facial expression of the person in the reference face pose image. A higher matching degree of the face texture data in the target image with the face texture data in the reference face image represents a higher similarity of a skin color of facial skin, luster information of the facial skin, wrinkle information of the facial skin and texture information of the facial skin in the target image with a skin color of facial skin, luster information of the facial skin, wrinkle information of the facial skin and texture information of the facial skin in the reference face image (it is visually perceived by the user that the person in the target image and the person in the reference face image are more likely to be the same person).

In a possible implementation, the face texture data and the first face mask are fused to obtain fused data containing both the face texture data of the target person and the target face pose, and then the fused data may be decoded to obtain the target image. Decoding may be deconvolution.

In another possible implementation, the face texture data may be decoded by multiple successive decoding layers, to obtain decoded face texture data with different sizes (namely, different decoding layers output decoded face texture data of different sizes). Then output data of each decoding layer is fused with the first face mask, so that a fusion effect of the face texture data and the first face mask can be improved under different sizes, and the quality of the finally obtained target image can be promoted. For example, as illustrated in FIG. 3, the face texture data is decoded by a first decoding layer, a second decoding layer, . . . , and an eighth decoding layer sequentially, to obtain the target image. Data obtained by fusing output data of the first decoding layer and a first stage of face mask serves as input data of the second decoding layer, data obtained by fusing output data of the second decoding layer and a second stage of face mask serves as input data of a third decoding layer, . . . , data obtained by fusing output data of a seventh decoding layer and a seventh stage of face mask serves as input data of the eighth decoding layer, and output data of the eighth decoding layer is finally taken as the target image. The seventh stage of face mask is the first face mask of the reference face pose image, and all of the first stage of face mask, the second stage of face mask, . . . , and the sixth stage of face mask may be obtained by downsampling the first face mask of the reference face pose image. The first stage of face mask has the same size as the output data of the first decoding layer, the second stage of face mask has the same size as the output data of the second decoding layer, . . . , and the seventh stage of face mask has the same size as the output data of the seventh stage of decoding layer. Downsampling may be linear interpolation, nearest neighbor interpolation or bilinear interpolation.

It is to be understood that the number of decoding layers illustrated in FIG. 3 is only an example provided in the embodiment and shall not constitute limitation to the disclosure.

The fusion may be concatenating two pieces of to-be-fused data in a channel dimension. For example, if the first stage of face mask contains 3 channels, and the output data of the first decoding layer contains 2 channels, the data obtained by fusing the first stage of face mask and the output data of the first decoding layer contains 5 channels.

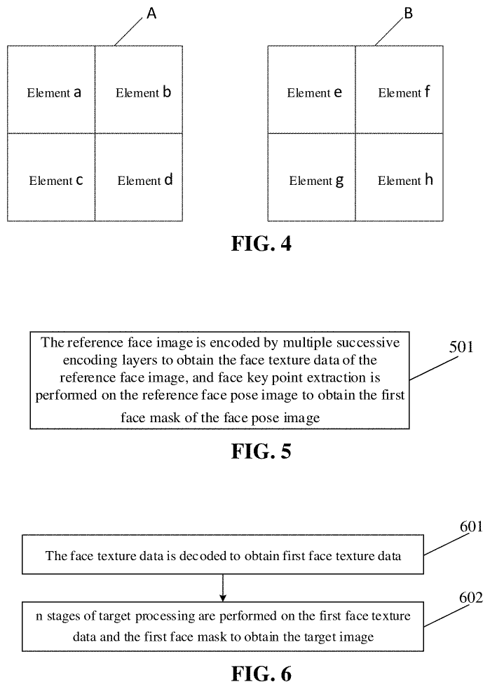

Fusion may also be addition of elements at the same position in the two pieces of to-be-fused data. The elements at the same position in the two pieces of data may be as illustrated in FIG. 4. An element ‘a’ is located at the same position in data A as where an element ‘e’ is located in data B. An element ‘b’ is located at the same position in the data A as where an element ‘f’ is located in the data B. An element ‘c’ is located at the same position in the data A as where an element ‘g’ is located in the data B. An element ‘d’ is located at the same position in the data A as where an element ‘h’ is located in the data B.

According to the embodiment, by encoding the reference face image, the face texture data of a target person in the reference face image can be obtained. By performing face key point extraction on the reference face pose image, the first face mask can be obtained. Then the target image can be obtained by fusing the face texture data with the first face mask to obtain fused data and decoding the fused data. The effect of changing the face pose of any target person can be achieved.

As illustrated in FIG. 5 is a possible implementation of action 102 according to an embodiment of the disclosure.

In 501, the reference face image are encoded by multiple successive encoding layers, to obtain the face texture data of the reference face image, and face key point extraction is performed on the reference face pose image to obtain the first face mask of the reference face pose image.

A process of performing face key point extraction on the reference face pose image to obtain the first face mask of the reference face pose image may refer to action 102 and will not be elaborated herein.

In the embodiment, the number of encoding layers is greater than or equal to 2. The multiple encoding layers are sequentially cascaded, namely output data of an encoding layer serves input data of an immediately following encoding layer. If the multiple encoding layers include an s^{th} encoding layer and an (s+1)^{th} encoding layer, input data of a first encoding layer in the multiple encoding layers is the reference face image, output data of the s^{th} encoding layer serves as input data of the (s+1)^{th} encoding layer, and output data of the last encoding layer is the face texture data of the reference face image. Each encoding layer includes a convolution layer, a normalization layer and an activation layer, and s is a positive integer greater than or equal to 1. By encoding the reference face image through the multiple successive encoding layers, the face texture data can be extracted from the reference face image, and face texture data extracted by each encoding layer is different. In particular, by encoding with the multiple encoding layers, the face texture data in the reference face image is extracted step by step, and information that is less important is also be removed step by step (here, the less important information refers to non-face texture data, including hair information and contour information of the face). Therefore, the face texture data extracted in a later encoding layer has a smaller size, and the skin color information of the facial skin, luster information of the facial skin, wrinkle information of the face skin and texture information of the facial skin in the face texture data extracted in the later encoding layer are more condensed. In such a manner, at the same time of obtaining the face texture data of the reference face image, the size of the image may be reduced, so as to alleviate a calculation burden of a system and improve an operating speed.

In a possible implementation, each encoding layer includes three processing layers, i.e., a convolution layer, a normalization layer and an activation layer. The three processing layers are sequentially cascaded. Namely, input data of the convolution layer is input data of the encoding layer, output data of the convolution layer serves as input data of the normalization layer, output data of the normalization layer serves as output data of the activation layer, and output data of the encoding layer is finally obtained through the normalization layer. A function of the convolution layer is realized through the process that convolution is performed on the input data of the encoding layer. Namely, a convolution kernel slides on the input data of the encoding layer; a value of an element in the input data of the encoding layer is multiplied by all values of the elements in the convolution kernel respectively, then a sum of all products obtained by the multiplication is determined as a value of the element; and all elements in the input data of the encoding layer are finally processed by sliding convolution kernel, thus obtaining data having subjected to the convolution. The normalization layer may be implemented by inputting the data having subjected to the convolution to a Batch Norm (BN) layer. Batch normalization is performed, by the BN layer, on the data having subjected to the convolution, so that the data having subjected to the convolution complies with a normal distribution that an average value is 0 and a variance is 1, thus eliminating correlation between different data in the data having subjected to the convolution, and to enable a difference in distribution between the different data in the data having subjected to the convolution to be prominent. Due to that capabilities of the previous convolution layer and normalization layer in learning, from data, complex mappings are relatively low, and complex data, for example an image, cannot not be processed through the convolution layer and the normalization layer only, nonlinear transformation needs to be performed on the normalized data to process complex data such as images. A nonlinear activation function is connected after the BN layer, and nonlinear transformation is performed on the normalized data through the nonlinear activation function to activate the normalized data, so as to extract the face texture data of the reference face image. Optionally, the nonlinear activation function is a ReLU.

According to the embodiment, by encoding the reference face image by successive encoding layers to reduce the size of the reference face image and obtain the face texture data of the reference face image, a data processing amount in subsequent face texture data-based processing can be reduced, and the processing speed can be increased. Though subsequently processing, a target image may be obtained based on the face texture data of the reference face image and any face pose (i.e., the first face mask) to obtain an image of the person in the reference face image at any face pose.

As illustrated in FIG. 6 is a schematic flowchart of a possible implementation of the action 103 according to an embodiment of the disclosure.

In 601, the face texture data is decoded to obtain first face texture data.

Decoding is a reverse process of encoding. By decoding the face texture data, the reference face image can be obtained. However, in order to fuse the face mask and the face texture data to obtain the target image, the face texture data is decoded by multiple stages and the face mask is fused with the face texture data during the multiple stages of decoding in the embodiment.

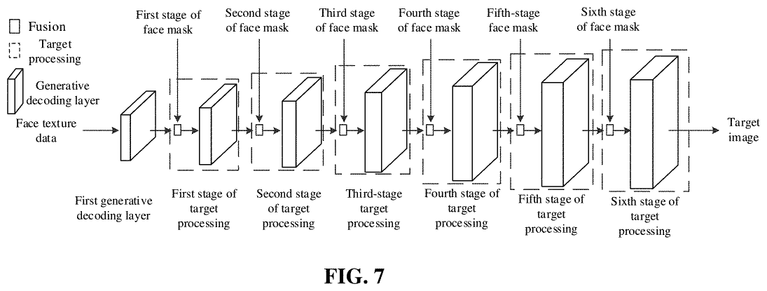

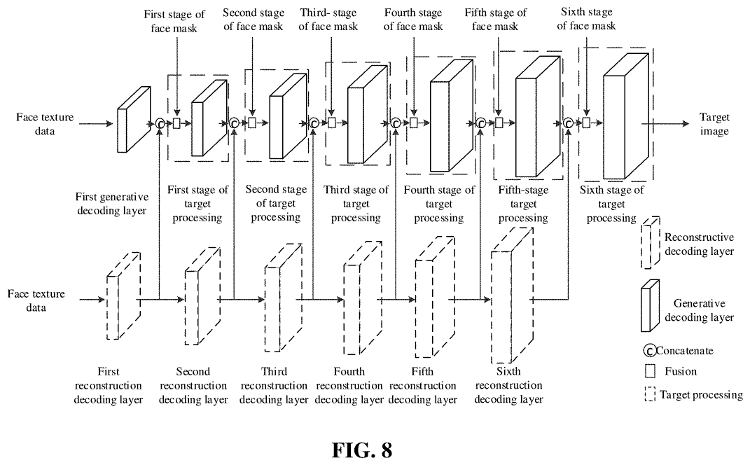

In a possible implementation, as illustrated in FIG. 7, the face texture data is decoded by a first generative decoding layer, a second generative decoding layer (i.e., a generative decoding layer in first stage of target processing), . . . , and a seventh generative decoding layer (i.e., a generative decoding layer in sixth stage of target processing) sequentially, to finally obtain the target image. The face texture data is input to the first generative decoding layer, and is decoded to obtain the first face texture data. In some other embodiments, the face texture data may also be firstly decoded by earlier ones of the generative decoding layers (for example, first two of the generative decoding layers) to obtain the first face texture data.

In 602, n stages of target processing are performed on the first face texture data and the first face mask to obtain the target image.

In the embodiment, n is a positive integer greater than or equal to 2. Target processing includes fusion and decoding. The first face texture data serves as input data of first stage of target processing, namely the first face texture data serves as to-be-fused data of the first stage of target processing. The to-be-fused data of the first stage of target processing is fused with a first stage of face mask to obtain first stage of fused data, and then the first stage of fused data is decoded to obtain output data of the first stage of target processing which serves as to-be-fused data of a second stage of target processing. In the second stage of target processing, input data of the second stage of target processing is fused with a second stage of face mask to obtain second stage of fused data, and then the second stage of fused data is decoded to obtain output data of the second stage of target processing which serves as to-be-fused data of a third stage of target processing. Similar operations are performed until output data of n^{th} stage of target processing is obtained as the target image. The n^{th} stage of face mask is the first face mask of the reference face pose image, and all of the first stage of face mask, second stage of face mask, . . . , and an (n−1)^{th} stage of face mask may be obtained by downsampling the first face mask of the reference face pose image. The first stage of face mask has the same size as the input data of the first stage of target processing, the second stage of face mask has the same size as the input data of the second stage of target processing, . . . , and the n^{th} stage of face mask has the same size as input data of the n^{th} stage of target processing.

Optionally, decoding includes deconvolution and normalization in the embodiment. Any one of the n stages of target processing is implemented by fusing the input data of the stage of target processing with data obtained by resizing the first face mask to obtain fused data, and then decoding the fused data. For example, for i^{th} stage of target processing in the n stages of target processing, input data of the i^{th} stage of target processing and the data obtained by resizing the first face mask are fused to obtain i^{th} stage of target fused data; and then the i^{th} stage of target fused data is decoded to obtain output data of the i^{th} stage of target processing; thus, the i^{th} stage of target processing of the input data of the i^{th} stage of target processing is completed.

By fusing face masks of different sizes (i.e., the data obtained after resizing the first face mask) with input data of different stages of target processing respectively, the fusion effect of the face texture data and the first face mask can be improved, and the quality of the finally obtained target image can be improved.

Resizing the first face mask may refer to upsampling the first face mask, or may be downsampling the first face mask. No limitation is set in the disclosure.

In a possible implementation, as illustrated in FIG. 7, the target image is obtained by performing first stage of target processing, second stage of target processing, . . . , and sixth stage of target processing on the first face texture data sequentially. In the case where face masks of different sizes are directly fused with input data of different stages of target processing, information in the face masks of the different sizes may be lost during the fused data is normalized in the decoding, thereby decreasing the quality of the finally obtained target image. Therefore, in the embodiment, a normalization form is determined according to face masks of different sizes, and input data of the target processing is normalized by the normalization form; thus fusion of the first face mask with input data of target processing is implemented. In such a manner, information contained in each element in the first face mask and information contained in an element at the same position in the input data of the target processing may be fused better, so that the quality of each pixel in the target image is improved. Optionally, a convolution kernel with a first predetermined size is used to perform convolution on the i^{th} stage of face mask to obtain first feature data, and a convolution kernel with a second predetermined size is used to perform convolution on the i^{th} stage of face mask to obtain second feature data. Then, a normalization form is determined according to the first feature data and the second feature data. The first predetermined size is different from the second predetermined size, and i is a positive integer greater than or equal to 1 and smaller than or equal to n.

In a possible implementation, affine transformation may be performed on the input data of the i^{th} stage of target processing to realize nonlinear transformation of the i^{th} stage of target processing, so as to realize more complex mapping, so that an image can be generated subsequently based on the data having subjected to the nonlinear normalization.

If the input data of the i^{th} stage of target processing is β=x_{1→m}, which contains m pieces of data in total, and an output is yᵢ=BN(x). Affine transformation performed on the input data of the i^{th} stage of target processing includes executing the following operations on the input data of the i^{th} stage of target processing. Firstly, an average value of the input data β=x_{1→m}, of the i^{th} stage of target processing is calculated, namely

$${μ}_{β} = \frac{1}{m} {\sum }_{i = 1}^{m} {x}_{i} .$$

Then, a variance of the input data of the i^{th} stage of target processing is determined according to the average value μ_{β}, namely

$${σ}_{β} = \frac{1}{m} {\sum }_{i = 1} {m ( {x}_{i} - {μ}_{β} )}^{2} .$$

Next, affine transformation is performed on the input data of the i^{th} stage of target processing according to the average value μ_{β} and the variance σ_{β}², to obtain xᵢ⁻. Finally, the result of the affine transformation is obtained based on a resizing variable γ and a translation variable δ, namely yᵢ=γxᵢ⁻+δ, where γ and δ may be obtained according to the first feature data and the second feature data. For example, the first feature data is taken as the resizing variable γ, and the second feature data is taken as δ.

After the normalization form is determined, the input data of the i^{th} stage of target processing may be normalized according to the normalization form to obtain the i^{th} stage of fused data. Then, the i^{th} stage of fused data may be decoded to obtain the output data of the i^{th} stage of target processing.

For better fusing the first face mask with the face texture data, the face texture data of the reference face image may be decoded by successive decoding layers to obtain face texture data of different sizes, and then the face mask and the output data of the target processing having the same size as each other are fused, so as to improve the fusion effect of the first face mask and the face texture data and improve the quality of the target image. In the embodiment, j stages of decoding is performed on the face texture data of the reference face image to obtain face texture data of different sizes. Input data of first stage of decoding in the j stages of decoding is the face texture data. The j stages of decoding include (k−1)^{th} stage of decoding and k^{th} stage of decoding, and output data of the (k−1)^{th} stage of decoding is input data of the k^{th} stage of decoding. Each stage of decoding includes activation, deconvolution and normalization, namely activation, deconvolution and normalization may be sequentially performed on input data of the stage of decoding to obtain output data of the stage of decoding. Here, j is a positive integer greater than or equal to 2, and k is a positive integer greater than or equal to 2 and smaller than or equal to j.

In a possible implementation, as illustrated in FIG. 8, the number of reconstructive decoding layers is the same as the number of stages of target processing, and output data of an r^{th} stage of decoding (i.e., output data of an r^{th} stage of reconstructive decoding layer) has the same size as the input data of the i^{th} stage of target processing. The output data of the r^{th} stage of decoding and the input data of the i^{th} stage of target processing are concatenated to obtain i^{th} stage of concatenated data; the i^{th} stage of concatenated data is taken as the to-be-fused data of the i^{th} stage of target processing, and the i^{th} stage of target processing is performed on the i^{th} stage of to-be-fused data, to obtain the output data of the i^{th} stage of target processing. In such a manner, the face texture data of different sizes of the reference face image can be better applied to obtain the target image, improving the quality of the obtained target image. Optionally, the concatenation includes concatenation in the channel dimension. Here, a process of performing the i^{th} stage of target processing on the i^{th} stage of to-be-fused data may refer to the previous possible implementation.

It is to be understood that the i^{th} stage of to-be-fused data in the target processing in FIG. 7 is the input data of the i^{th} stage of target processing, the i^{th} stage of of to-be-fused data in FIG. 8 is data obtained by concatenating the input data of the i^{th} stage of target processing and the output data of the r^{th} stage of decoding. The subsequent process of fusing the i^{th} stage of to-be-fused data and the i^{th} stage of face mask is the same in FIG. 7 and FIG. 8.

It is to be understood that both the number of stages of target processing in FIG. 7 and FIG. 8 and the number of times of concatenation in FIG. 8 are examples provided in the embodiment of the disclosure and shall not constitute limitation to the disclosure. For example, six times of concatenation are contained in FIG. 8, namely the output data of each decoding layer is concatenated with the input data of the same size of the target processing. Although the quality of the finally obtained target image may be improved by each concatenation (namely the higher the number of times of concatenation, the higher the quality of the target image), each time of concatenation brings about large data processing amount and increases the consumed processing resources (calculation resources of an execution subject of the embodiment). Therefore, the number of times of concatenation may be adjusted according to a practical usage of the user. For example, the output data of some (for example, the final one or more) of reconstructive decoding layers may be concatenated with respective input data of the same size of the target processing.

According to the embodiment, during processing the face texture data by successive stages of target processing, by fusing the face masks of different sizes obtained by resizing the first face mask with respective input data of the target processing, the fusion effect of the first face mask and the face texture data is improved, and the matching degree of the face pose of the target image with the face pose of the reference face pose image is further improved. The face texture data of the reference face image is decoded by successive decoding layers to obtain decoded face texture data of different sizes (namely, different reconstructive decoding layers output data with different sizes), and the decoded face texture data is fused with the input data of the target processing having the same size. In this way, the fusion effect of the first face mask and the face texture data can be further improved, and the matching degree of the face texture data of the target image with the face texture data of the reference face image can be improved. With the two matching degrees improved through the method provided in the embodiment, the quality of the target image can be improved.

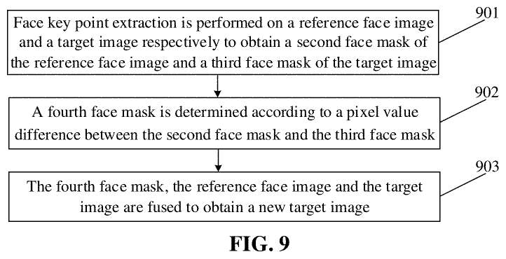

The embodiments of the disclosure also provide a solution of processing a face mask of a reference face image and a face mask of a target image, to enrich details (including beard information, wrinkle information and texture information of the skin) in the target image and further improve the quality of the target image. FIG. 9 illustrates a schematic flowchart of another method for image processing according to an embodiment of the disclosure.

In 901, face key point extraction is performed on a reference face image and a target image respectively to obtain a second face mask of the reference face image and a third face mask of the target image.

In the embodiment, position information of a face contour, position information of five organs, and facial expression information may be extracted from the image through face key point extraction. Face key point extraction may be performed on the reference face image and the target image respectively to obtain the second face mask of the reference face image and the third face mask of the target image. The second face mask, the third face mask, the reference face image and the reference target image all have a same size. The second face mask contains position information of key points of the face contour, position information of key points of the five organs, and facial expression in the reference face image, and the third face mask contains position information of key points of the face contour, position information of key points of the five organs, and facial expression in the target image.

In 902, a fourth face mask is determined according to a pixel value difference between the second face mask and the third face mask.

The pixel value difference (for example, statistical data like an average value, a variance and relevance) between the second face mask and the third face mask obtained by comparison may be used to obtain a difference of detail between the reference face image and the target image, and the fourth face mask may be determined based on the difference of detail.

In a possible implementation, an affine transformation form is determined according to an average value (referred to as a pixel average value hereinafter) between pixel values of pixels at the same position in the second face mask and the third face mask and a variance (referred to as a pixel variance hereinafter) between the pixel values of the pixels at the same position in the second face mask and the third face mask. Then, affine transformation may be performed on the second face mask and the third face mask according to the affine transformation form to obtain the fourth face mask. The pixel average value may be taken as a resizing variable for affine transformation, and the pixel variance may be taken as a translation variable for affine transformation. Alternatively, the pixel average value may be taken as the translation variable for affine transformation, and the pixel variance may be taken as the resizing variable for affine transformation. Meanings of the resizing variable and the translation variable may refer to action 602. In the embodiment, the fourth face mask has the same size as the second face mask and the third face mask. Each pixel in the fourth face mask has a numerical value ranging from 0 to 1 optionally. If the numerical value of a pixel is closer to 1, it indicates that, at a position of the pixel, a pixel value difference between a pixel in the reference face image and a pixel in the target image is greater. For example, the position where a first pixel is located in the reference face image is the same as the position where a second pixel is located in the target image and the position where a third pixel is located in the fourth face mask. The greater a pixel value difference between the first pixel and the second pixel, the greater a numerical value of the third pixel.

In 903, the fourth face mask, the reference face image and the target image are fused to obtain a new target image.

If a pixel value difference between pixels at the same position in the target image and the reference face image is smaller, the face texture data in the target image is more highly matched with the face texture data in the reference face image. Through processing in 902, the difference (referred to as a pixel value difference hereinafter) between the pixel values of the pixels at the same position in the reference face image and the target image can be determined. Therefore, the target image and the reference face image may be fused according to the fourth face mask to reduce a pixel value difference between pixels at the same position in a fused image and the reference face image to achieve a higher matching degree of details between the fused image and the reference face image. In a possible implementation, the reference face image and the target image may be fused through the following formula:

I_{fuse}=I_{gen}*(1−mask)+I_{ref}*mask Formula (1).

Here, I_{fuse} is the fused image, I_{gen} is the target image, I_{ref} is the reference face image, and mask is the fourth face mask. (1−mask) refers to subtracting numerical values of pixels in the fourth face mask from numeric values at same positions in a face mask which has the same size as the fourth face mask and in which a numerical value of each pixel is 1. I_{gen}*(1−mask) refers to multiplying each numerical value in the face mask obtained by (1−mask) by a numeric value at the same positions in the reference face image. I_{ref}*mask refers to multiplying each numeric value of pixel in the fourth face mask and a numeric value of pixel at the same position in the reference face image.

Through I_{gen}*(1−mask), a pixel value at a position in the target image corresponding to a smaller pixel value difference with the reference face image can be reinforced, and a pixel value at a position in the target image corresponding to a greater pixel value difference with the reference face image can be weakened. Through I_{ref}*mask, a pixel value at a position in the reference face image corresponding to a greater pixel value difference with the target image can be reinforced, and a pixel value at a position in the reference face image corresponding to a smaller pixel value difference with the target image can be weakened. Then, pixel values of pixels in an image obtained by I_{gen}*(1−mask) may be added to pixels values of pixels at the same positions in an image obtained by I_{ref}*mask. Details of the target image can be strengthened, and a matching degree of the details in the target image with details in the reference face image is improved.

For example, it is assumed that a position where a pixel ‘a’ is located in the reference face image is the same as a position where a pixel ‘b’ is located in the target image and a position where a pixel ‘c’ is located in the fourth face mask, and a pixel value of the pixel ‘a’ is 255, a pixel value of the pixel ‘b’ is 0 and a numerical value of the pixel ‘c’ is 1. A pixel value of a pixel ‘d’ in an image obtained by I_{ref}*mask is 255 (a position where the pixel ‘d’ is located in the image obtained by I_{ref}*mask is the same as a position where the pixel ‘a’ is located in the reference face image), and a pixel value of a pixel ‘e’ in an image obtained by I_{gen}*(1−mask) is 0 (a position where the pixel ‘e’ is located in the image obtained by I_{gen}*(1−mask) is the same as the position where the pixel ‘a’ is located in the reference face image). Then, the pixel value of the pixel ‘d’ is added to the pixel value of the pixel ‘e’ to determine that a pixel value of a pixel ‘f’ in a fused image is 255. That is, the pixel value of the pixel ‘f’ in the image obtained by fusion is the same as the pixel value of the pixel ‘a’ in the reference face image.

In the embodiment, the new target image is the fused image. According to the embodiment, the fourth face mask is obtained through the second face mask and the third face mask, and the reference face image and the target image are fused according to the fourth face mask, so that detail information in the target image can be improved. Furthermore, the position information of the five organs, the position information of the face contour and the expression information in the target image can be reserved, and the quality of the target image is thus improved.

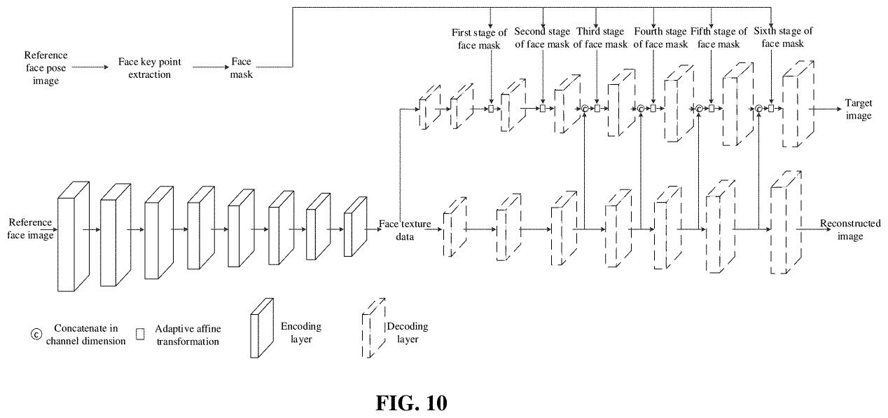

The embodiments of the disclosure also provide a face generation network for implementing the method in the abovementioned embodiment provided in the disclosure. FIG. 10 illustrates a schematic structural diagram of a face generation network according to an embodiment of the disclosure. As illustrated in FIG. 10, input of the face generation network includes a reference face pose image and a reference face image. Face key point extraction is performed on the reference face pose image to obtain a face mask. The face mask may be downsampled to obtain a first stage of face mask, a second stage of face mask, a third stage of face mask, a fourth stage of face mask and a fifth stage of face mask, and the face mask is taken as a sixth stage of face mask. All the first stage of face mask, the second stage of face mask, the third stage of face mask, the fourth stage of face mask and the fifth stage of face mask are obtained by different downsampling. The downsampling may be implemented by any one of the following: bilinear interpolation, nearest neighbor interpolation, high-order interpolation, convolution, and pooling.

The reference face image is encoded by successive multiple encoding layers, to obtain face texture data. Then, through decoding the face texture data by multiple successive decoding layers, a reconstructed image can be obtained. A difference between the reconstructed image, obtained by performing stage-wise encoding (namely, encoding with successive encoding layers) and then stage-wise decoding (namely, decoding with successive decoding layers) on the reference face image, and the reference face image may be measured through a pixel value difference between pixels at the same position in the reconstructed image and the reference face image. If the difference is smaller, it indicates that the quality of face texture data (including the face texture data and output data of each decoding layer in the diagram) with different sizes obtained by encoding and decoding the reference face image is higher (here, high quality refers to that information in the face texture data of different sizes is highly matched with face texture information in the reference face image).

The first stage of face mask, the second stage of face mask, the third stage of face mask, the fourth stage of face mask, the fifth stage of face mask and the sixth stage of face mask may be fused with corresponding data respectively during stage-wise decoding of the face texture data, to obtain a target image. The fusion includes adaptive affine transformation, namely convolution is performed on the first stage of face mask or the second stage of face mask or the third stage of face mask or the fourth stage of face mask or the fifth stage of face mask or the sixth stage of face mask by use of a convolution kernel with a first predetermined size and a convolution kernel with a second predetermined size respectively, to obtain third feature data and fourth feature data. Then an affine transformation form is determined according to the third feature data and the fourth feature data, and finally, affine transformation is performed on corresponding data according to the affine transformation form. In such a manner, a fusion effect of the face mask and the face texture data may be improved, and the quality of the generated image (i.e., the target image) is improved.

By concatenating output data of decoding layers obtained during performing stage-wise decoding on the face texture data to obtain the reconstructed image, and output data of decoding layers obtained during performing stage-wise decoding on the face texture data to obtain the target image, the fusion effect of the face mask and the face texture data is further improved, and the quality of the target image is further improved.

It can be seen from the embodiment of the disclosure that, according to the disclosure, the face mask obtained from the reference face pose image and the face texture data obtained from the reference face image are processed separately, so that a face pose of any person in the reference face pose image and face texture data of any person in the reference face image can be obtained. Therefore, a target image which contains the face pose in the reference face image and contains the face texture data in the reference face image may subsequently be obtained by making processing based on the face mask and the face texture data, namely “face swapping” of any person can be implemented.

Based on the abovementioned implementation concept and implementations, the disclosure provides a method for training a face generation network, to enable a trained face generation network to obtain a high-quality face mask (namely face pose information in the face mask is highly matched with face pose information in a reference face pose image) from the reference face pose image, to obtain high-quality face texture data (namely face texture information in the face texture data is highly matched with face texture information in the reference face image) from a reference face image and to obtain a high-quality target image based on the face mask and the face texture data. In a process of training the face generation network, a first sample face image and a first sample face pose image may be input to the face generation network to obtain a first generated image and a first reconstructed image. A person in the first sample face image is different from a person in the first sample face pose image.

The first generated image is obtained based on decoding the face texture data. That is, if an effect of a face texture feature extracted from the first sample face image is better (namely face texture information in the extracted face texture feature is highly matched with face texture information in the first sample face image), the quality of the subsequently obtained first generated image is higher (namely face texture information in the first generated image is highly matched with the face texture information in the first sample face image). Therefore, in the embodiment, face feature extraction is performed on the first sample face image and the first generated image respectively to obtain feature data of the first sample face image and face feature data of the first generated image, and then a difference between the feature data of the first sample face image and the face feature data of the first generated image is evaluated by a face feature loss function to obtain a first loss. The face feature extraction may be implemented through a face feature extraction algorithm. No limitation is set in the disclosure.

As described in 102, the face texture data may be considered as personal identity information. That is, if the face texture information in the first generated image is highly matched with the face texture information in the first sample face image, a person in the first generated image is very similar as a person in the first sample face image (it is visually perceived by a user that the person in the first generated image and the person in the first sample face image are more likely to be the same person). Therefore, in the embodiment, a difference between the face texture information of the first generated image and the face texture information of the first sample face image is evaluated through a perceptual loss function, to obtain a second loss.

If an overall similarity between the first generated image and the first sample face image is higher (here, the overall similarity includes a pixel value difference between pixels at the same position in the two images, a difference of overall color between the two images, and a matching degree between background regions in the two images except face regions), the quality of the obtained first generated image is higher (if all other image contents, except different expressions and contours of the persons, are more similar between the first generated image and the first sample face image, it is visually perceived by the user that the person in the first generated image and the person in the first sample face image are more likely to be the same person and the image content in the first generated image except the face region are more similar with the image content in the first sample face image except the face region). Therefore, in the embodiment, the overall similarity between the first sample face image and the first generated image is evaluated by a reconstruction loss function, to obtain a third loss.

In a process of obtaining the first generated image based on the face texture data and the face mask, by concatenating decoded face texture data of different sizes (i.e., output data of each decoding layer produced during obtaining the first reconstructed image based on the face texture data) to output data of a respective decoding layer produced during obtaining the first generated image based on the face texture data, the fusion effect of the face texture data and the face mask is improved. That is, if the quality of the output data of each decoding layer produced during obtaining the first reconstructed image based on the face texture data is higher (which means that information in the output data of the decoding layer is highly matched with information in the first sample face image), the quality of the obtained first generated image is higher, and the obtained first reconstructed image is more similar to the first sample face image. Therefore, in the embodiment, the similarity between the first reconstructed image and the first sample face image is evaluated by a reconstruction loss function to obtain a fourth loss.

It is to be pointed out that, in the process of training the face generation network, the reference face image and the reference face pose image are input to the face generation network to obtain the first generated image and the first reconstructed image, and a face pose of the first generated image is kept consistent with a face pose of the first sample face image as much as possible through the loss functions, so that when the multiple encoding layer in the trained face generation network are used to perform stage-wise encoding on the reference face image to obtain the face texture data, the multiple encoding layers focus more on extraction of a face texture feature from the reference face image and extract no face pose feature from the reference face image to obtain face pose information. In this way, when the target image is generated by use of the trained face generation network, the face pose information of the reference face image contained in the obtained face texture data may be reduced, and the quality of the target image is better improved.

The face generation network provided in the embodiment is a generation network in a Generative Adversarial Network (GAN). The first generated image is generated through the face generation network, namely the first generated image is not a true image (i.e., an image shot by a camera or a photographic device). For improving truthness of the obtained first generated image (if the truthness of the first generated image is higher, the first generated image is more like a true image from the visual angle of the user). The truthness of the target image may be evaluated by a loss function of a GAN to obtain a fifth loss. A first network loss of the face generation network may be obtained based on the first loss, the second loss, the third loss, the fourth loss and the fifth loss mentioned above. In particular, the following formula may be referred to:

Lₜₒₜₐₗ=α₁L₁+α₂L₂+α₃L₃+α₄L₄+α₅L₅ Formula (2).

Here, Lₜₒₜₐₗ is the network loss, L₁ is the first loss, L₂ is the second loss, L₃ is the third loss, L₄ is the fourth loss, L₅ is the fifth loss, and α₁, α₂, α₃, α₄ and α₅ may be any natural numbers. Optionally, α₄=25, α₃=25, and α₁=α₂=α₅=1. The face generation network may be trained by back propagation based on the first network loss obtained through the formula (2). Training is completed until the network converges, and the trained face generation network is obtained. Optionally, in the process of training the face generation network, the training samples may also include a second sample face image and a second sample pose image. The second sample pose image may be obtained by imposing random disturbance to the second sample face image to change a face pose in the second sample face image (for example, deviating positions of the five organs in the second sample face image and/or the position of the face contour in the second sample face image). The second sample face image and the second sample face pose image may be input to the face generation network for training, to obtain a second generated image and a second reconstructed image. Then, a sixth loss is obtained according to the second sample face image and the second generated image (a process of obtaining the sixth loss may refer to a process of obtaining the first loss according to the first sample face image and the first generated image). A seventh loss is obtained according to the second sample face image and the second generated image (a process of obtaining the seventh loss may refer to a process of obtaining the second loss according to the first sample face image and the first generated image). An eighth loss is obtained according to the second sample face image and the second generated image (a process of obtaining the eighth process may refer to a process of obtaining the third loss according to the first sample face image and the first generated image). A ninth loss is obtained according to the second sample face image and the second reconstructed image (a process of obtaining the ninth loss may refer to a process of obtaining the fourth loss according to the first sample face image and the first reconstructed image). A tenth loss is obtained according to the second generated image (a process of obtaining the tenth loss may refer to a process of obtaining the fifth loss according to the first generated image). Then, a second network loss of the face generation network may be obtained based on the sixth loss, the seventh loss, the eighth loss, the ninth loss, the tenth loss and a formula (3) which may specifically be the following formula:

Lₜₒₜₐₗ₂=α₆L₆+α₇L₇+α₈L₈+α₉L₉+α₁₀L₁₀ Formula (3).

Here, Lₜₒₜₐₗ₂ is the second network loss, L₆ is the sixth loss, L₇ is the seventh loss, L₈ is the eighth loss, L₉ is the ninth loss, L₁₀ is the tenth loss, and α₆, α₇, α₈, α₉ and α₁₀ may be any natural numbers. Optionally, α₉=25, α₈=25, and α₆=α₇=α₁₀=1.

The second sample face image and the second sample face pose image are taken as a training set, so that the diversity of images in the training set for the face generation network can be improved. A training effect of the face generation network can be improved, and the quality of the target image generated through the trained face generation network can be improved.

In the training process, by enabling a face pose in the first generated image to be the same as a face pose in the first sample pose image or enabling a face pose in the second generated image to be the same as a face pose in the second sample face pose image, the trained face generation network focuses more on extraction of the face texture feature from the reference face image to obtain the face texture data when encoding the reference face image to obtain the face texture data and extracts no face pose feature from the reference face image to obtain the face pose information. Therefore, when a target image is generated by the trained face generation network, the face pose information of the reference face image in the obtained face texture data may be reduced, and the quality of the target image is better improved. It is to be understood that, based on the face generation network and the method for training a face generation network provided in the embodiments, there may be one image used in training. Namely one image containing a person is input to the face generation network as a sample face image, together with any sample face pose image. Training of the face generation network is completed by use of the training method, to obtain the trained face generation network.

It is also to be pointed out that the target image obtained by use of the face generation network provided in the embodiment may include “missing information” in the reference face image. The “missing information” refers to information caused due to difference between a facial expression of the person in the reference face image and a facial expression of the person in the reference face pose image. For example, the facial expression of the person in the reference face image is that the eyes are closed, and the facial expression of the person in the reference face pose image is that the eyes are opened. The facial expression in the target image needs to be kept consistent with the facial expression of the person in the reference face pose image. However, there is no eye appearing in the reference face image. Information of an eye region in the reference face image is “missing information”.

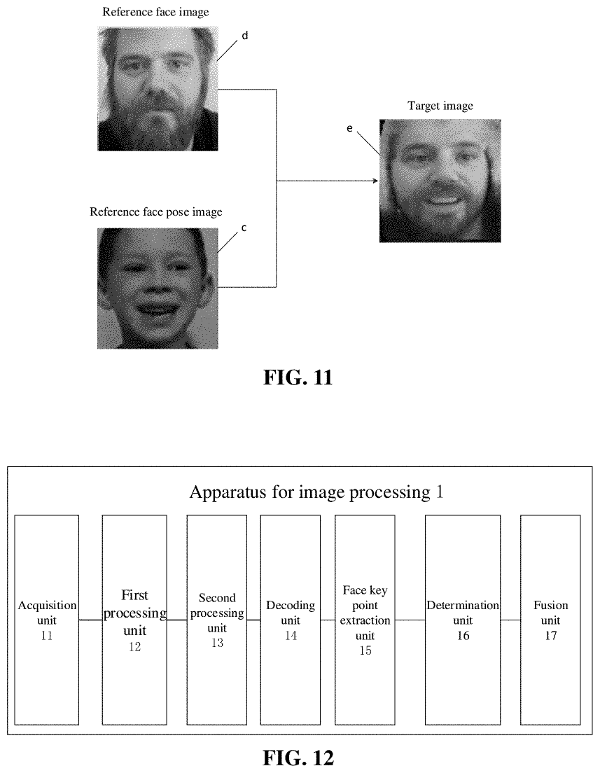

For another example (Example 1), as illustrated in FIG. 11, a facial expression of a person in a reference face image ‘d’ is that the mouth is closed, and a facial expression of a person in a reference face pose image ‘c’ is that the mouth is opened. In this case, information of a tooth region in ‘d’ is “missing information”.

The face generation network provided in the embodiment of the disclosure learns a mapping relationship between “missing information” and face texture data through the training process. When the target image is obtained by use of the trained face generation network, if there is “missing information” in the reference face image, the “missing information” may be estimated for the target image according to the face texture data of the reference face image and the mapping relationship.

Example 1 is continued, ‘c’ and ‘d’ are input to the face generation network, and the face generation network obtains face texture data of ‘d’ from ‘d’, determines, from the face texture data learned in the training process, face texture data highest matching with the face texture data of ‘d’ as target face texture data. Then, target tooth information corresponding to the target face texture data is determined according to a mapping relationship between tooth information and face texture data, and image content of an image region in a target image ‘e’ is determined according to the target tooth information.

According to the embodiment, the face generation network is trained based on the first loss, the second loss, the third loss, the fourth loss and the fifth loss, so that the trained face generation network may acquire a face mask from any reference face pose image and acquire face texture data from any reference face image, and then may obtain a target image based on the face mask and the face texture data. That is, through the face generation network and the trained face generation network obtained by the method for training a face generation network provided in the embodiment, a face of any person may be swapped into any image. In other words, the technical solutions provided in the disclosure are universal (namely any person may be determined as a target person). Based on the method for image processing provided in the embodiments of the disclosure and the face generation network and the method for training a face generation network provided in the embodiments of the disclosure, some possible application scenarios are also provided in the embodiments of the disclosure. When photographing for a person, due to the influence of external factors (for example, movement of the photographed person, shake of a shooting apparatus and low luminous intensity of a shooting environment), a shot photo of the person may have the problems of blurring (blurring of a face region in the embodiment), poor light (poor light in the face region in the embodiment) and the like. By means of the technical solution provided in the embodiments of the disclosure, a terminal (for example, a mobile phone and a computer), may perform face key point extraction on a blurred image or an image with poor illumination (i.e., a portrait with the problem of blurring) to obtain a face mask, then encode a clear image containing a same person as the blurred image to obtain face texture data of the person and finally obtain a target image based on the face mask and the face texture data. A face pose in the target image is the face pose in the blurred image or the image with poor illumination.

In addition, the user may also obtain images with various expressions through the technical solution provided in the disclosure. For example, in the case where a person A finds expression of a person in an image ‘a’ interesting and wants to have an image with this expression of his/her own, the person A may input a photo of his/her own and the image ‘a’ to a terminal. The terminal processes the photo of the person A and the image ‘a’ through the technical solution provided in the disclosure by taking the photo of the person A as a reference face image and taking the image ‘a’ as a reference pose image, to obtain a target image. In the target image, the person A has the same expression as the person in the image ‘a’.

In another possible implementation scenario, a person B finds a video in a movie interesting and wants to see the effect of replacing the face of an actor in the movie with his/her own face. The person B may input a photo of his/her own (i.e., a to-be-processed face image) and the video (i.e., a to-be-processed video) to a terminal. The terminal processes the photo of the person B and each frame of image in the video through the technical solution provided in the disclosure by taking the photo of the person B as a reference face image and taking each frame of image in the video as a reference face pose image, to obtain a target video. The actor in the target video is “swapped” with B.

In another possible implementation scenario, a person C wants to swap a face pose in an image ‘d’ with a face pose in an image ‘c’. As illustrated in FIG. 11, the image ‘c’ may be input to a terminal as a reference face pose image and the image ‘d’ may be input to a terminal as a reference face image. The terminal processes ‘c’ and ‘d’ according to the technical solution provided in the disclosure to obtain a target image ‘e’.

It is to be understood that, when a target image is obtained by use of the method or the face generation network provided in the embodiments of the disclosure, one or more face images may be taken as reference face images at the same time, and one or more face images may also be taken as reference face pose images at the same time.

For example, an image ‘f’, an image ‘g’ and an image ‘h’ are sequentially input to the terminal as reference face images, and an image ‘i’, an image T and an image ‘k’ are sequentially input to the terminal as face pose images. In such case, by use of the technical solutions provided in the disclosure, the terminal generates a target image ‘m’ based on the image ‘f’ and the image ‘I’, generates a target image ‘n’ based on the image ‘g’ and the image T and generates a target image ‘p’ based on the image ‘h’ and the image ‘k’.

For another example, an image ‘q’ and an image ‘r’ are sequentially input to the terminal as reference face images, and an image ‘s’ is input to the terminal as a face pose image. In such case, by use of the technical solutions provided in the disclosure, the terminal generates a target image T based on the image ‘q’ and the image ‘s’ and generates a target image ‘u’ based on the image ‘r’ and the image ‘s’.

It can be seen from some application scenarios provided in the embodiments of the disclosure that, by means of the technical solutions provided in the disclosure, a face of any person can be swapped into any image or video to obtain an image or video of a target person (i.e., a person in a reference face image) at any face pose.

It can be understood by those skilled in the art that, in the method of the specific implementations, the writing sequence of actions does not mean a strict sequence of execution and is not intended to form any limitation to the implementation process, and a specific sequence of execution of the actions should be determined by functions and probable internal logic thereof.

The method of the embodiments of the disclosure is elaborated above, and an apparatus of the embodiments of the disclosure will be provided below.

FIG. 12 illustrates a schematic structural diagram of an apparatus for image processing according to an embodiment of the disclosure. The apparatus 1 includes an acquisition unit 11, a first processing unit 12 and a second processing unit 13. Optionally, the apparatus 1 may further include at least one of: a decoding unit 14, a face key point extraction unit 15, a determination unit 16 and a fusion unit 17.

The acquisition unit 11 is configured to acquire a reference face image and a reference face pose image.

The first processing unit 12 is configured to encode the reference face image to obtain face texture data of the reference face image and perform face key point extraction on the reference face pose image to obtain a first face mask of the reference face pose image.

The second processing unit 13 is configured to obtain a target image according to the face texture data and the first face mask.

In a possible implementation, the second processing unit 13 is configured to: decode the face texture data to obtain first face texture data; and perform n stages of target processing on the first face texture data and the first face mask to obtain the target image. The n stages of target processing include an (m−1)^{th} stage of target processing and an m^{th} stage of target processing, input data of a first stage of target processing in the n stages of target processing is the face texture data. Output data of the (m−1)^{th} stage of target processing serves as input data of the m^{th} stage of target processing. An stage of target processing in the n stages of target processing includes fusing input data of the stage of target processing with data obtained by resizing the first face mask to obtain fused data, and decoding the fused data. n is a positive integer greater than or equal to 2. m is a positive integer greater than or equal to 2 and smaller than or equal to n. i is a positive integer greater than or equal to 1 and smaller than or equal to n.

In another possible implementation, the second processing unit 13 is configured to: obtain, according to the input data of the i^{th} stage of target processing, to-be-fused data of the i^{th} stage of target processing. The second processing unit 13 is configured to fuse the to-be-fused data of the i^{th} stage of target processing with an i^{th} stage of face mask to obtain i^{th} stage of fused data. The i^{th} stage of face mask is obtained by downsampling the first face mask, and the i^{th} stage of face mask has a same size as the input data of the i^{th} stage of target processing. The second processing unit 13 is configured to decode the i^{th} stage of fused data to obtain output data of the i^{th} stage of target processing.

In a possible implementation, the apparatus 1 further includes: a decoding unit 14. The decoding unit is configured to: after the reference face image is encoded to obtain the face texture data of the reference face image, perform j stages of decoding on the face texture data. Input data of a first stage of decoding in the j stages of decoding is the face texture data. The j stages of decoding includes a (k−1)^{th} stage of decoding and a k^{th} stage of decoding. Output data of the (k−1)^{th} stage of decoding serves as input data of the k^{th} stage of decoding. j is a positive integer greater than or equal to 2. k is a positive integer greater than or equal to 2 and smaller than or equal to j. The second processing unit 13 is configured to: concatenate output data of an r^{th} stage of decoding in the j stages of decoding and the input data of the i^{th} stage of target processing, to obtain an i^{th} stage of concatenated data as the to-be-fused data of the i^{th} stage of target processing. The output data of the r^{th} stage of decoding has a same size as the input data of the i^{th} stage of target processing. r is a positive integer greater than or equal to 1 and smaller than or equal to j.

In a possible implementation, the second processing unit 13 is configured to: concatenate the output data of the r^{th} stage of decoding and the input data of the i^{th} stage of target processing in a channel dimension to obtain the i^{th} stage of concatenated data.

In a possible implementation, the r^{th} stage of decoding includes: sequentially performing activation, deconvolution, and normalization on input data of the r^{th} stage of decoding to obtain the output data of the r^{th} stage of decoding.

In a possible implementation, the second processing unit 13 is configured to: perform convolution on the i^{th} stage of face mask by use of a convolution kernel with a first predetermined size, to obtain first feature data, and perform convolution on the i^{th} stage of face mask by use of a convolution kernel with a second predetermined size, to obtain second feature data; determine a normalization form according to the first feature data and the second feature data; and normalize, according to the normalization form, the to-be-fused data of the i^{th} stage of target processing to obtain the i^{th} stage of fused data.

In a possible implementation, the normalization form includes a target affine transformation form; and the second processing unit 13 is configured to: perform, according to the target affine transformation form, affine transformation on the to-be-fused data of the i^{th} stage of target processing to obtain the i^{th} stage of fused data.

In a possible implementation, the second processing unit 13 is configured to: fuse the face texture data with the first face mask to obtain target fused data; and decode the target fused data to obtain the target image.

In a possible implementation, the first processing unit 12 is configured to: encode the reference face image by a plurality of successive encoding layers, to obtain the face texture data of the reference face image. The plurality of successive encoding layers include an s^{th} encoding layer and an (s+1)^{th} encoding layer. Input data of a first encoding layer in the plurality of encoding layers is the reference face image. Output data of the s^{th} encoding layer serves as input data of the (s+1)^{th} encoding layer. s is a positive integer greater than or equal to 1.

In a possible implementation, each of the plurality of encoding layers includes a convolution layer, a normalization layer and an activation layer.

In a possible implementation, the apparatus 1 further includes: a face key point extraction unit 15, a determination unit 16 and a fusion unit 17. The face key point extraction unit 15 is configured to perform face key point extraction on the reference face image and the target image respectively to obtain a second face mask of the reference face image and a third face mask of the target image. The determination unit 16 is configured to determine a fourth face mask according to a pixel value difference between the second face mask and the third face mask. A pixel value difference between a first pixel in the reference face image and a second pixel in the target image is positively correlated with a pixel value of a third pixel in the fourth face mask. A position where the first pixel is located in the reference face image is the same as a position where the second pixel is located in the target image and a position where the third pixel is located in the fourth face mask. The fusion unit 17 is configured to fuse the fourth face mask, the reference face image and the target image to obtain a new target image.

In a possible implementation, the determination unit 16 is configured to: determine an affine transformation form according to an average value of a pixel value of a pixel in the second face mask and a pixel value of a pixel in the third face mask and a variance of the pixel value of the pixel in the second face mask and the pixel value of the pixel in the third face mask. A position where the pixel in the second face mask is located in the second face mask is the same as a position where the pixel in the third face mask is located in the third face mask. The determination unit 16 is configured to: perform affine transformation on the second face mask and the third face mask according to the affine transformation form to obtain the fourth face mask.

In a possible implementation, a method for image processing executed by the apparatus 1 is applied to a face generation network. The apparatus 1 for image processing is configured to execute a process of training the face generation network. The process of training the face generation network includes the following. A training sample is input to the face generation network to obtain a first generated image of the training sample and a first reconstructed image of the training sample. The training sample includes a sample face image and a first sample face pose image, and the first reconstructed image is obtained by encoding and decoding the sample face image. A first loss is obtained according to a face feature matching degree between the sample face image and the first generated image. A second loss is obtained according to a difference between face texture information in the first sample face image and face texture information in the first generated image. A third loss is obtained according to a pixel value difference between a fourth pixel in the first sample face image and a fifth pixel in the first generated image. A fourth loss is obtained according to a pixel value difference between a sixth pixel in the first sample face image and a seventh pixel in the first reconstructed image. A fifth loss is obtained according to truthness of the first generated image. A position where the fourth pixel is located in the first sample face image is the same as a position where the fifth pixel is located in the first generated image. A position where the sixth pixel is located in the first sample face image is the same as a position where the seventh pixel is located in the first reconstructed image. Higher truthness of the first generated image represents a higher probability that the first generated image is a true picture. A first network loss of the face generation network is obtained according to the first loss, the second loss, the third loss, the fourth loss and the fifth loss. The process of training the face generation network includes: adjusting a parameter of the face generation network based on the first network loss.

In a possible implementation, the training sample further includes a second sample face pose image, the second sample face pose image is obtained by imposing random disturbance to a second sample face image to change positions of five organs in the second sample face image, or to change a position of a face contour in the second sample face image, or to change both the positions of the five organs and the position of the face contour in the second sample face image. The process of training the face generation network further includes the following. The second sample face image and the second sample face pose image are input to the face generation network to obtain a second generated image of the training sample and a second reconstructed image of the training sample. The second reconstructed image is obtained by encoding and decoding the second sample face image. A sixth loss is obtained according to a face feature matching degree between the second sample face image and the second generated image. A seventh loss is obtained according to a difference between face texture information in the second sample face image and face texture information in the second generated image. An eighth loss is obtained according to a pixel value difference between an eighth pixel in the second sample face image and a ninth pixel in the second generated image. A ninth loss is obtained according to a pixel value difference between a tenth pixel in the second sample face image and an eleventh pixel in the second reconstructed image. A tenth loss is obtained according to truthness of the second generated image. A position where the eighth pixel is located in the second sample face image is the same as a position where the ninth pixel is located in the second generated image. A position where the tenth pixel is located in the second sample face image is the same as a position where the eleventh pixel is located in the second reconstructed image. Higher truthness of the second generated image represents a higher probability that the second generated image is a true picture. A second network loss of the face generation network is obtained according to the sixth loss, the seventh loss, the eighth loss, the ninth loss and the tenth loss. A parameter of the face generation network is adjusted based on the second network loss.

In a possible implementation, the acquisition unit 11 is configured to: receive a to-be-processed face image input by a user to a terminal; acquire a to-be-processed video containing a face; and obtain a target video by taking the to-be-processed face image as the reference face image and taking each image in the to-be-processed video as the face pose image.

According to the embodiments of the disclosure, by encoding a reference face image, face texture data of a target person in the reference face image can be obtained, and by performing face key point extraction on the reference face pose image, a face mask can be obtained. Then a target image can be obtained by fusing the face texture data with the face mask to obtain fused data, and then decoding the fused data. As such, a face pose of any target person can be changed.

In some embodiments, functions or modules of the apparatus provided in the embodiment of the disclosure may be configured to execute the method described in the method embodiment and specific implementation thereof may refer to the descriptions about the method embodiment and will not be elaborated herein for brevity.

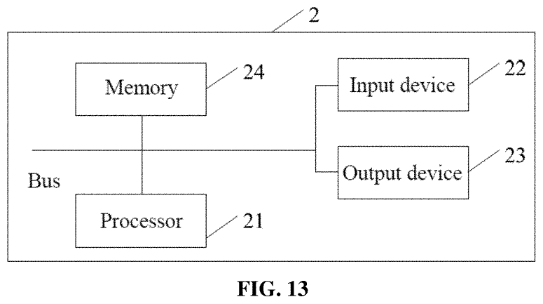

FIG. 13 illustrates a schematic diagram of a hardware structure of an apparatus for image processing according to an embodiment of the disclosure. The apparatus 2 for image processing includes a processor 21 and a memory 22. Optionally, the apparatus 2 for image processing may further include an input device 23 and an output device 24. The processor 21, the memory 22, the input device 23 and the output device s 24 are coupled through a connector. The connector includes various interfaces, transmission cables, buses, or the like, and no limitation is set in the embodiment of the disclosure. It is to be understood that, in the embodiments of the disclosure, coupling refers to interconnection implemented in a specific manner, including direct connection or in direct connection realized through another device, for example, connection through various interfaces, transmission cables and buses.

The processor 21 may be one or more Graphics Processing Units (GPUs). Under the condition that the processor 21 is one GPU, the GPU may be a single-core GPU or may be a multi-core GPU. Optionally, the processor 21 may be a processor set composed of multiple GPUs, and multiple processors are coupled with one another through one or more buses. Optionally, the processor may also be a processor of another type and the like, and no limitation is set in the embodiment of the disclosure. The memory 22 may be configured to store computer program instructions and various computer program codes including a program code configured to execute the solutions of the disclosure. Optionally, the memory includes, but not limited to, a Random Access Memory (RAM), a Read-Only Memory (ROM), an Erasable Programmable ROM (EPROM) or a Compact Disc Read-Only Memory (CD-ROM). The memory is configured for related instructions and data. The input device 23 is configured to input data and/or signals, and the output device 24 is configured to output data and/or signals. The output device 23 and the input device 24 may be independent devices and may also be an integral device.

It can be understood that, in the embodiments of the disclosure, the memory 22 may not only be configured to store related instructions but also be configured to store related images. For example, the memory 22 may be configured to store a reference face image and a reference face pose image acquired by the input device 23, or the memory 22 may also be configured to store a target image obtained by the processor 21 through search and the like. Data specifically stored in the memory is not limited in the embodiments of the disclosure. It can be understood that FIG. 13 only illustrates a simplified design of the apparatus for image processing. During practical application, the apparatus for image processing may further include other essential components, including, but not limited to, any number of input/output devices, processors, memories and the like. All devices for image processing capable of implementing the embodiments of the disclosure shall fall within the scope of protection of the disclosure.

In the embodiments of the disclosure, also provided is a processor configured to execute the method for image processing.

In the embodiments of the disclosure, also provided is an electronic device including a processor and a memory configured to store processor-executable instructions. The processor is configured to call the instructions stored in the memory to execute the method for image processing.

In the embodiments of the disclosure, also provided is a computer-readable storage medium having stored thereon computer program instructions that, when executed by a processor, implement the method for image processing. The computer-readable storage medium may be a volatile computer-readable storage medium or a non-volatile computer-readable storage medium.

In the embodiments of the disclosure, also provided is a computer program including computer-readable code that, when running in a device, causes a processor in the device to executes instructions configured to implement the method for image processing provided in any above embodiment.

In the embodiments of the disclosure, also provided is another computer program product, which is configured to store computer-readable instructions that, when executed, cause a computer to execute the operations of the method for image processing provided in any above embodiment.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working processes of the system, device and unit described above may refer to the corresponding processes in the method embodiment and will not be elaborated herein for convenient and brief description. Those skilled in the art may also clearly know that the embodiments of the disclosure are described with different focuses. For convenient and brief description, elaborations about the same or similar parts may be omitted in different embodiments, and thus parts that are not described or detailed in an embodiment may refer to records in the other embodiments.

In some embodiments provided by the disclosure, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between various displayed or discussed components may be indirect coupling or communication connection implemented through some interfaces, device or units, and may be electrical and mechanical or in other forms.

The units described as separate parts may or may not be physically separated, and parts displayed as units may or may not be physical units, and namely may be located in the same place, or may also be distributed to multiple network units. Part or all of the units may be selected to achieve the purposes of the solutions of the embodiments according to a practical requirement.

In addition, functional units in the embodiments of the disclosure may be integrated into a processing unit, or may physically exist independently, and two or more than two units may also be integrated into one unit.

The embodiments may be implemented completely or partially through software, hardware, firmware or any combination thereof. During implementation with the software, the embodiments may be implemented completely or partially in form of computer program product. The computer program product includes one or more computer instructions. When the computer program instructions are loaded and executed on a computer, the flows or functions according to the embodiments of the disclosure are completely or partially generated. The computer may be a universal computer, a dedicated computer, a computer network or another programmable device. The computer instructions may be stored in a computer-readable storage medium or transmitted through the computer-readable storage medium. The computer instructions may be transmitted from one website, computer, server or data center to another website, computer, server or data center in a wired manner (for example, through a coaxial cable, an optical fiber and a Digital Subscriber Line (DSL)) or wirelessly (for example, infrared, radio and microwaves). The computer-readable storage medium may be any available medium accessible for the computer or a data storage device, such as a server and a data center, including one or more integrated available media. The available medium may be a magnetic medium (for example, a floppy disk, a hard disk and a magnetic tape), an optical medium (for example, a Digital Versatile Disc (DVD)), a semiconductor medium (for example, a Solid State Disk (SSD)) or the like.

It can be understood by those of ordinary skill in the art that all or part of the flows in the method of the abovementioned embodiments may be completed by instructing related hardware through a computer program. The program may be stored in a computer-readable storage medium, and when the program is executed, the flows of each method embodiment may be realized. The storage medium may be a volatile storage medium or a nonvolatile storage medium, including: various media capable of storing program codes such as a ROM, a RAM, a magnetic disk or an optical disk.

1. A method for image processing, comprising:
acquiring a reference face image and a reference face pose image;
encoding the reference face image to obtain face texture data of the reference face image;
performing face key point extraction on the reference face pose image to obtain a first face mask of the reference face pose image; and
obtaining a target image according to the face texture data and the first face mask.

2. The method of claim 1, wherein obtaining the target image according to the face texture data and the first face mask comprises:
decoding the face texture data to obtain first face texture data; and
performing n stages of target processing on the first face texture data and the first face mask to obtain the target image, wherein the n stages of target processing comprise an (m−1)^{th} stage of target processing and an m^{th} stage of target processing, input data of a first stage of target processing in the n stages of target processing is the face texture data, output data of the (m−1)^{th} stage of target processing serves as input data of the m^{th} stage of target processing, an i^{th} stage of target processing in the n stages of target processing comprises fusing input data of the i^{th} stage of target processing with data obtained by resizing the first face mask to obtain fused data and decoding the fused data, n is a positive integer greater than or equal to 2, m is a positive integer greater than or equal to 2 and smaller than or equal to n, and i is a positive integer greater than or equal to 1 and smaller than or equal to n.

3. The method of claim 2, wherein fusing the input data of the i^{th} stage of target processing with the data obtained by resizing the first face mask to obtain the fused data and decoding the fused data comprises:
obtaining, according to the input data of the i^{th} stage of target processing, to-be-fused data of the i^{th} stage of target processing;
fusing the to-be-fused data of the i^{th} stage of target processing with an i^{th} stage of face mask to obtain i^{th} stage of fused data, wherein the i^{th} stage of face mask is obtained by downsampling the first face mask, and the i^{th} stage of face mask has a same size as the input data of the i^{th} stage of target processing; and
decoding the i^{th} stage of fused data to obtain output data of the i^{th} stage of target processing.

4. The method of claim 3, after encoding the reference face image to obtain the face texture data of the reference face image, the method further comprises:
performing j stages of decoding on the face texture data, wherein input data of a first stage of decoding in the j stages of decoding is the face texture data, the j stages of decoding comprises a (k−1)^{th} stage of decoding and a k^{th} stage of decoding, output data of the (k−1)^{th} stage of decoding serves as input data of the k^{th} stage of decoding, j is a positive integer greater than or equal to 2, and k is a positive integer greater than or equal to 2 and smaller than or equal to j; and
obtaining, according to the input data of the i^{th} stage of target processing, the to-be-fused data of the i^{th} stage of target processing comprises:
concatenating output data of an r^{th} stage of decoding in the j stages of decoding and the input data of the i^{th} stage of target processing to obtain an i^{th} stage of concatenated data as the to-be-fused data of the i^{th} stage of target processing, wherein the output data of the r^{th} stage of decoding has a same size as the input data of the i^{th} stage of target processing, and r is a positive integer greater than or equal to 1 and smaller than or equal to j.

5. The method of claim 4, wherein concatenating the output data of the r^{th} stage of decoding in the j stages of decoding and the input data of the i^{th} stage of target processing to obtain the i^{th} stage of concatenated data comprises:
concatenating the output data of the r^{th} stage of decoding and the input data of the i^{th} stage of target processing in a channel dimension to obtain the i^{th} stage of concatenated data.

6. The method of claim 4, wherein the r^{th} stage of decoding comprises:
sequentially performing activation, deconvolution, and normalization on input data of the r^{th} stage of decoding to obtain the output data of the r^{th} stage of decoding.

7. The method of claim 3, wherein fusing the to-be-fused data of the i^{th} stage of target processing and the i^{th} stage of face mask to obtain the i^{th} stage of fused data comprises:
performing convolution on the i^{th} stage of face mask by use of a convolution kernel with a first predetermined size, to obtain first feature data, and performing convolution on the i^{th} stage of face mask by use of a convolution kernel with a second predetermined size, to obtain second feature data;
determining a normalization form according to the first feature data and the second feature data; and
normalizing, according to the normalization form, the to-be-fused data of the i^{th} stage of target processing to obtain the i^{th} stage of fused data.

8. The method of claim 7, wherein the normalization form comprises a target affine transformation form; and
normalizing, according to the normalization form, the to-be-fused data of the i^{th} stage of target processing to obtain the i^{th} stage of fused data comprises:
performing, according to the target affine transformation form, affine transformation on the to-be-fused data of the i^{th} stage of target processing to obtain the i^{th} stage of fused data.

9. The method of claim 1, wherein obtaining the target image according to the face texture data and the first face mask comprises:
fusing the face texture data with the first face mask to obtain target fused data; and
decoding the target fused data to obtain the target image.

10. The method of claim 1, wherein encoding the reference face image to obtain the face texture data of the reference face image comprises:
encoding the reference face image by a plurality of successive encoding layers, to obtain the face texture data of the reference face image, wherein the plurality of encoding layers comprise an s^{th} encoding layer and an (s+1)^{th} encoding layer, input data of a first encoding layer in the plurality of encoding layers is the reference face image, output data of the s^{th} encoding layer serves as input data of the (s+1)^{th} encoding layer, and s is a positive integer greater than or equal to 1.

11. The method of claim 10, wherein each of the plurality of encoding layers comprises a convolution layer, a normalization layer and an activation layer.

12. The method of claim 1, further comprising:
performing face key point extraction on the reference face image and the target image respectively to obtain a second face mask of the reference face image and a third face mask of the target image;
determining a fourth face mask according to a pixel value difference between the second face mask and the third face mask, wherein a pixel value difference between a first pixel in the reference face image and a second pixel in the target image is positively correlated with a pixel value of a third pixel in the fourth face mask, and a position where the first pixel is located in the reference face image is the same as a position where the second pixel is located in the target image and a position where the third pixel is located in the fourth face mask; and
fusing the fourth face mask, the reference face image and the target image to obtain a new target image.

13. The method of claim 12, wherein determining the fourth face mask according to the pixel value difference between the second face mask and the third face mask comprises:
determining an affine transformation form according to an average value of a pixel value of a pixel in the second face mask and a pixel value of a pixel in the third face mask and a variance of the pixel value of the pixel in the second face mask and the pixel value of the pixel in the third face mask, wherein a position where the pixel in the second face mask is located in the second face mask is the same as a position where the pixel in the third face mask is located in the third face mask; and
performing affine transformation on the second face mask and the third face mask according to the affine transformation form to obtain the fourth face mask.

14. The method of claim 1, applied to a face generation network, wherein
a process of training the face generation network comprises:
inputting a training sample to the face generation network to obtain a first generated image of the training sample and a first reconstructed image of the training sample, wherein the training sample comprises a sample face image and a first sample face pose image, and the first reconstructed image is obtained by encoding and decoding the sample face image;
obtaining a first loss according to a face feature matching degree between the sample face image and the first generated image; obtaining a second loss according to a difference between face texture information in the first sample face pose image and face texture information in the first generated image; obtaining a third loss according to a pixel value difference between a fourth pixel in the first sample face pose image and a fifth pixel in the first generated image; obtaining a fourth loss according to a pixel value difference between a sixth pixel in the first sample face pose image and a seventh pixel in the first reconstructed image; and obtaining a fifth loss according to truthness of the first generated image, wherein a position where the fourth pixel is located in the first sample face pose image is the same as a position where the fifth pixel is located in the first generated image, a position where the sixth pixel is located in the first sample face pose image is the same as a position where the seventh pixel is located in the first reconstructed image, and higher truthness of the first generated image represents a higher probability that the first generated image is a true picture;
obtaining a first network loss of the face generation network according to the first loss, the second loss, the third loss, the fourth loss and the fifth loss; and
adjusting a parameter of the face generation network based on the first network loss.

15. The method of claim 14, wherein the training sample further comprises a second sample face pose image, the second sample face pose image is obtained by imposing random disturbance to a second sample face image to change positions of five organs in the second sample face image, or to change a position of a face contour in the second sample face image, or to change both the positions of the five organs and the position of the face contour in the second sample face image, and
the process of training the face generation network further comprises:
inputting the second sample face image and the second sample face pose image to the face generation network to obtain a second generated image of the training sample and a second reconstructed image of the training sample, wherein the second reconstructed image is obtained by encoding and decoding the second sample face image;
obtaining a sixth loss according to a face feature matching degree between the second sample face image and the second generated image; obtaining a seventh loss according to a difference between face texture information in the second sample face image and face texture information in the second generated image; obtaining an eighth loss according to a pixel value difference between an eighth pixel in the second sample face image and a ninth pixel in the second generated image; obtaining a ninth loss according to a pixel value difference between a tenth pixel in the second sample face image and an eleventh pixel in the second reconstructed image; and obtaining a tenth loss according to truthness of the second generated image, wherein a position where the eighth pixel is located in the second sample face image is the same as a position where the ninth pixel is located in the second generated image, a position where the tenth pixel is located in the second sample face image is the same as a position where the eleventh pixel is located in the second reconstructed image, and higher truthness of the second generated image represents a higher probability that the second generated image is a true picture;
obtaining a second network loss of the face generation network according to the sixth loss, the seventh loss, the eighth loss, the ninth loss and the tenth loss; and
adjusting a parameter of the face generation network based on the second network loss.

16. The method of claim 1, wherein acquiring the reference face image and the reference face pose image comprises:
receiving a to-be-processed face image input by a user to a terminal;
acquiring a to-be-processed video containing a face; and
obtaining a target video by taking the to-be-processed face image as the reference face image and taking each image in the to-be-processed video as the reference face pose image.

17. An apparatus for image processing, comprising:
a processor; and
a memory configured to store instructions which, when being executed by the processor, cause the processor to:
acquire a reference face image and a reference face pose image;
encode the reference face image to obtain face texture data of the reference face image and perform face key point extraction on the reference face pose image to obtain a first face mask of the reference face pose image; and
obtain a target image according to the face texture data and the first face mask.

18. The apparatus of claim 17, wherein in obtaining the target image according to the face texture data and the first face mask, the processor is caused to:
decode the face texture data to obtain first face texture data; and
perform n stages of target processing on the first face texture data and the first face mask to obtain the target image, wherein the n stages of target processing comprise an (m−1)^{th} stage of target processing and an m^{th} stage of target processing, input data of a first stage of target processing in the n stages of target processing is the face texture data, output data of the (m−1)^{th} stage of target processing serves as input data of the m^{th} stage of target processing, an i^{th} stage of target processing in the n stages of target processing comprises fusing input data of the i^{th} stage of target processing with data obtained by resizing the first face mask to obtain fused data and decoding the fused data, n is a positive integer greater than or equal to 2, m is a positive integer greater than or equal to 2 and smaller than or equal to n, and i is a positive integer greater than or equal to 1 and smaller than or equal to n.

19. The apparatus of claim 18, wherein in fusing the input data of the i^{th} stage of target processing with the data obtained by resizing the first face mask to obtain the fused data and decoding the fused data, the processor is caused to:
obtain, according to the input data of the i^{th} stage of target processing, to-be-fused data of the i^{th} stage of target processing;
fuse the to-be-fused data of the i^{th} stage of target processing with an i^{th} stage of face mask to obtain i^{th} stage of fused data, wherein the i^{th} stage of face mask is obtained by downsampling the first face mask, and the i^{th} stage of face mask has a same size as the input data of the i^{th} stage of target processing; and
decode the i^{th} stage of fused data to obtain output data of the i^{th} stage of target processing.

20. A non-transitory computer-readable storage medium having stored thereon a computer program comprising program instructions that, when executed by a processor of an electronic device, causes the processor to execute a method for image processing, the method comprising:
acquiring a reference face image and a reference face pose image;
encoding the reference face image to obtain face texture data of the reference face image;
performing face key point extraction on the reference face pose image to obtain a first face mask of the reference face pose image; and
obtaining a target image according to the face texture data and the first face mask.
